(19) United States
(12) Patent Application Publication
(10) Pub. No.: US 2009/0262345 A1
(43) Pub. Date: Oct. 22, 2009

(54) IMMERSION PROBE FOR LIPS APPARATUSES

(76) Inventors: Johann Gruber, Hohenzell (AT); Max Dallinger, Linz (AT)

Correspondence Address: GREENBLUM & BERNSTEIN, P.L.C., 1950 ROLAND CLARKE PLACE, RESTON, VA, 20191, US

(21) Appl. No.: 12/300,089

(22) PCT Filed: Apr. 30, 2007
(86) PCT No.: PCT/AT07/00204

§ 371 Date: May 11, 2009

(30) Foreign Application Priority Data
May 9, 2006 (AT) A 794/2006

(51) Int. Cl. G01J 3/30; G01N 1/10

(52) U.S. Cl. 356/318; 356/246

(57) ABSTRACT

The invention relates to an immersion probe (1) for a device for carrying out laser-induced plasma spectroscopy in a liquid or solid free-flowing material, such as a metallic melt, which immersion probe (1) has a tubular section (4) extending from a foot-side end (2) of the immersion probe (1) about a longitudinal axis (X) of the same and an opening for material to flow in. In order to be able to reliably determine, in particular, a chemical composition of a melt independently of an angle of inclination of the immersion probe with respect to a surface of the melt, it is provided according to the invention that the tubular section (4) is embodied essentially closed or closeable on the foot-side end (2) and has a lateral opening (5) through which the material can be inserted into the tubular section as a free flowing jet (12) directed at an angle (α) to the longitudinal axis (X).

The invention relates to an immersion probe for a device for carrying out laser-induced plasma spectroscopy in a liquid or solid free-flowing material, such as a metallic melt, which immersion probe has a tubular section extending from a foot-side end of the immersion probe about a longitudinal axis of the same and an opening for material to flow in.

Furthermore, the invention relates to a device for determining a physical and/or chemical property of a liquid or solid free-flowing material such as a metallic melt, in particular for carrying out laser-induced plasma spectroscopy, comprising an immersion probe which has a tubular section extending from a foot-side end of the immersion probe extending about a longitudinal axis of the same with an opening for material to flow in, and an analysis device connected to the immersion probe, with which a property of the material flowing into the immersion probe can be analyzed.

Finally, the invention relates to a method for determining a physical and/or chemical property of a liquid or solid free-flowing material, such as a metallic melt, in particular for carrying out laser-induced plasma spectroscopy, wherein an immersion probe having a tubular section with an opening is inserted into the material and material is allowed to flow into it, wherein properties of the material flowing in are analyzed.

A determining or monitoring of chemical compositions of liquid or solid free-flowing materials is essential with many chemical processes nowadays and is one of the most important measures of a quality control. While in the past to this end samples were chiefly taken by hand and analyzed in an external laboratory, the trend nowadays is to determine chemical compositions directly on-site or in-situ in the material in order to be able to obtain measurement results more quickly and thus optionally to be able to intervene in a process more quickly in a regulative manner.

Laser-induced plasma spectroscopy (LIPS) represents a particularly effective and therefore attractive method for determining a chemical composition of solid or liquid materials. In this method, a plasma is ignited on a surface of a material to be examined, e.g., by impingement with a high-energy laser beam. The electromagnetic radiation emitted by this plasma is characteristic of a composition of the material on its surface. Based on a spectral analysis of the emitted electromagnetic radiation, a chemical composition of the material can be fundamentally determined very precisely and within a short time.

Based on the effectiveness of laser-induced plasma spectroscopy and the possibility of being able to determine a chemical composition within a short time, there is also an interest in using this type of spectroscopy with melt metallurgical processes. Since a melt as a rule is covered on its surface with material foreign to the melt, e.g., slag with steel melts or dross with aluminum melts, LIPS devices with tubular immersion probes are used for this purpose, which can be inserted into a melt.

These immersion probes comprise essentially a foot-side open tube in which an overpressure can be generated. For the purpose of generating the overpressure, the tube is closed at its head-side end and equipped with a gas supply. The head-side end has a window through which laser light can be introduced to ignite and maintain a plasma. Radiation emitted by the plasma can also exit through the window, and can be fed to a light-guiding device, e.g., an optical waveguide and subsequently to a spectrometer or detector. In addition a focusing device is usually provided in the immersion probe or in the tube in order to focus a plasma-generating laser beam on a material surface as well as to collect radiation emitted by the plasma.

According to the prior art, there are two variants for igniting a plasma and analyzing its emitted radiation using an immersion probe inside a melt. In a first variant, an inert gas is blown in through the tubular section of the immersion probe at such high pressure that in the area of the introduced immersion probe a melt level is pressed against a hydrostatic pressure approximately in the area of an end-side opening of the immersion probe. A plasma is ignited on the melt surface thus locally adjusted, and the radiation emitted thereby is analyzed in that the emitted radiation, after passing through the tubular section of the immersion probe and the window thereof, is fed to an analysis device, in particular a spectrometer, by means of an optical wave guide. In a second variant according to the prior art, the tubular section of an immersion probe is likewise acted on with pressure, wherein a pressure is, however, lower and selected such that a melt level lies within the immersion probe or a tubular section of the same. After adjustment of a melt level inside the immersion probe, a plasma is ignited on the melt located in the immersion probe and in turn radiation emitted thereby is analyzed.

Immersion probes according to the prior art have a number of disadvantages. For example, even with the use of an inert gas, due to the long time period necessary for an adjustment of a melt level stable in height before a measurement it cannot always be ensured that a melt surface is oxide-free, which can lead to false measurement results.

Another serious disadvantage of known immersion probes is that it is extremely difficult during a measuring period to guarantee a constant height of the melt level or of a melt surface on which a plasma is ignited. However, if a height of the melt level changes, the plasma no longer lies in the focus of a lens via which the radiation emitted by the plasma is collected and ultimately fed to an analysis device. This represents a possible error source in a determination of a chemical composition. Since as a rule laser light is also focused onto the melt surface via the same lens, with sufficiently large changes in height of the melt level, moreover, the plasma can no longer be maintained.

Another disadvantage is that with analysis on a surface of a melt that is in surface contact with the other molten bath, oscillations of the melt surface cannot be ruled out, which can likewise lead to incorrect measurement results.

Another disadvantage of known immersion probes results from the fact that when they are used, an overpressure must be generated in the immersion probe in order to adjust a melt level for a measurement. However, measuring under overpressure can, as is scientifically proven (Tjong Jie Lie et al., Spectrochimica Acta B 61 (2006), pages 104 through 112; Tariq Mahmood Naeem et al., Spectrochimica Acta B 58 (2003), pages 891 through 899), lead to low signal yields.

Another serious disadvantage of known immersion probes lies in that, particularly when a melt is analyzed inside an immersion probe, the immersion probe must be inserted into the material to be examined in an exactly perpendicular manner. Namely, if the immersion probe is inserted into a melt in a tilted manner, the surface of the melt is tilted relative to a laser beam guided along the longitudinal axis of the immersion probe, with which laser beam the plasma is ignited, which leads to different measurement results than with a perpendicular position of the melt surface relative to the laser beam. In this case measurement results are therefore very dependent on the angle of inclination of the immersion probe with respect to a melt surface, which dependence can hardly be calibrated or corrected.

The disadvantages set forth above can also be given in general with devices for the determination of a physical and/or chemical property of a liquid or solid free-flowing material when they are equipped with immersion probes according to the prior art. Analogously, possibilities of analysis and informative value or reliability of corresponding methods are limited.

Based on this prior art, the object of the invention is to disclose an immersion probe of the type referenced at the outset, in which disadvantages of the prior art are eliminated.

Another object of the invention is to disclose a device of the type mentioned at the outset in which the disadvantages of immersion probes associated with the prior art are eliminated at least in part.

Finally, an object of the invention is to disclose a method of the type mentioned at the outset which makes it possible with constant probe spacing to reliably determine at any desired point of the material and independent of an angle of inclination of an immersion probe with respect to a surface of the material to be examined a physical and/or chemical property of the same.

The first objective of disclosing an immersion probe of the type mentioned at the outset in which disadvantages of the prior art are eliminated, is attained through an immersion probe according to claim 1. Advantageous further developments of an immersion probe according to the invention are the subject matter of claims 2 through 20.

The advantages obtained through the invention are to be seen in particular in that with their insertion or introduction into a liquid or solid free-flowing material, the material flows in at a constant angle to the longitudinal axis of the immersion probe. Since an inflow direction relative to the longitudinal axis is exclusively established through the lateral opening provided, and due to a high inflow speed of the free jet of several meters per second is essentially independent of gravity, it is irrelevant whether the immersion probe is inserted perpendicular or at an angle to a bath surface or a surface of a solid free-flowing material. In contrast to the known solutions according to the prior art, the immersion probe therefore does not need to be positioned rigidly, but can be inserted as desired and in particular also guided by hand into a melt and tilted.

Another advantage of an immersion probe according to the invention lies in that a constant material flow through the lateral opening provided is given during a measurement. In particular with metallic melts, a pure oxide-free or slag-free melt is thus always guided from a molten bath to measurement. Corresponding problems that are connected with a slag or a dross are therefore avoided.

Another advantage of an immersion probe according to the invention is that the opening is positioned at a fixed height of the immersion probe, which is why a jet-shaped insertion of material at a constant height is guaranteed during a measurement. A height of the material surface to be analyzed is thus constant and problems are ruled out that result from a melt level varying in height, e.g., varying distance of a plasma from the focusing device.

A still further advantage of an immersion probe according to the invention is to be seen in that it renders possible a measurement at underpressure. Carrying out laser-induced plasma spectroscopy at underpressure has the advantage that higher signal yields are obtained, which in turn has a favorable impact on a signal to noise ratio and thus on a quality of the measurement or analysis.

Furthermore, an immersion probe according to the invention is excellently suitable for carrying out pyrometrical measurements or for determining a temperature of the melt, since the jet entering is free from an oxide layer that is also interfering in this respect.

An angle at which material can be inserted into the tubular section as a free-flowing jet aligned to the longitudinal axis can be selected in a broad range and can be, for example, 45° to 135°. In order to have particularly simple geometric conditions during a measurement, it is advantageous if the opening is embodied such that the angle is approximately a right angle.

It is also advantageous if the opening has a rectangular cross section, the shorter sides of which run parallel to the longitudinal axis. In use, an areal inflow of material can thereby be achieved, which enlarges a potential measurement area and facilitates an ignition of a plasma.

With an ignition probe according to the invention, the tubular section can in principle be embodied with any desired cross section. For reasons of a simple producibility of the immersion probe, it is preferred, however, if the tubular section is embodied with a circular cross section. If this is the case, it is furthermore expedient if the tubular section is embodied in a planar manner in the area of the lateral opening on the inside. Through this structural measure, a parallel inflow of the material is achieved and an embodiment of a jet tapering conically towards the center of the immersion probe is prevented. To put it another way, a constant material flow is given and inhomogeneities are avoided in all areas of the surface to be analyzed, which leads to particularly exact analysis results.

For several reasons it is furthermore particularly favorable if means for producing underpressure or a vacuum are provided in the tubular section. On the one hand carrying out laser-induced plasma spectroscopy at underpressure is preferred with regard to high signal yields. On the other hand, it can be necessary in particular when a hydrostatic pressure of a melt is insufficient to press material through the opening or when a surface tension of the material to be examined is too great to cause an automatic inflow of the material, to force an inflow of material into the immersion probe by applying an underpressure. This can also be necessary in particular when a measurement is taken just below a surface of a molten bath and a hydrostatic pressure exerted by the melt is not sufficient to press melt through the lateral opening or the lateral gap. In addition, with underpressure above all with aluminum melts hydrogen escapes, which is then located in the immersion probe so that a hydrogen content in the aluminum melt can be concluded through analysis of the gas composition in the immersion probe.

In a particularly preferred variant of an immersion probe according to the invention, at least one further second opening is provided in the area of the foot-side end, and the lateral opening lies between the second opening and a head-side end of the immersion probe. Although material thus also enters into the immersion probe in the area of the foot-side end during a measurement, this has no impact, since the measurement is taken on the free jet lying closer on the head-side end anyway. After a measurement has been carried out, however, an important advantage is achieved in that the entire material located in the immersion probe can be discharged through the second opening provided in the area of the foot-side end.

In order to avoid as far as possible disturbances caused by a foot-side inflow of material during a measurement, it is advantageous if the at least one further second opening is made laterally.

In order to make it possible to empty the immersion probe as quickly as possible after a measurement, it can be provided that a free cross section of the second opening is greater than a free cross section of the lateral opening.

Since the immersion probe is continuously filled with melt from the foot-side end during a measurement if a second opening is provided on the foot-side end, it is advantageous if the lateral opening is located at half the height of the tubular section or higher. It can thus be ensured that a measurement can be carried out and completed unhindered on the free jet-shaped material before a melt level in the immersion probe has reached the lateral opening.

With respect to the quickest possible emptying of the immersion probe after a measuring operation, it has further proven to be expedient if means are provided for pressure application on the tubular section. This makes it possible to quickly press out material located in the immersion probe via a second opening provided on the foot-side end and to empty the immersion probe before a further measurement.

In order to still further reduce the time for an emptying of then immersion probe after a measuring operation, a component can be provided for closing the lateral opening. In this respect it is also advantageous if a component for closing the at least one further second opening is provided, since in this case a foot-side inflow of material can be suppressed during a measurement so that as a result only material is collected in the immersion probe which enters through the lateral opening as a jet. Correspondingly, after a measuring operation less material is present in the immersion probe and consequently less material also needs to be emptied.

A particularly advantageous variant is characterized in that in the tubular section a component is provided by means of which one of the openings alternatively can be closed. For example, during a measurement material can flow in through the lateral opening, whereas an inflow of material is prevented at the foot-side end. Conversely, after a measurement, material collected in the immersion probe can be blown out through a foot-side opening and at the same time a further inflow of material through the lateral opening is suppressed. In this context it is particularly advantageous if the component can be activated by generation of an underpressure or overpressure in the tubular section, wherein the second opening can be closed through generation of an underpressure. With this variant the advantages explained above of a measurement at underpressure and blowing out at overpressure are combined with the advantages of a closing of individual openings during or after a measurement.

Particularly with respect to metallic melts, which can act very aggressively, it has proven to be expedient for ensuring stable or constant measuring conditions for the tubular section of the immersion probe to comprise a ceramic, in particular silicon nitride.

Alternatively thereto it can also be provided for the tubular section to comprise a steel, which is preferably coated or provided with a facing material in order to increase its durability under operating conditions.

It can also be favorable for the tubular section to comprise a steel and a ceramic insert defining the lateral opening to be releasably attached in the tubular section. This variant is characterized in that it is cost-effective as well as designed for a long service life. To this end, the tubular section is produced from a steel in less critical parts, whereas a ceramic insert with greater durability is provided in the more critical area of the lateral opening. A detachable attachment of the insert in addition provides the advantage that it can be easily replaced in the case of wear, without the entire immersion probe having to be replaced.

In order to prevent as far as possible a clogging of individual openings, it can further be provided with an immersion probe according to the invention for a filter to be respectively arranged in front of the opening or the openings on the outside.

Furthermore, it can be advisable for the tubular section to be removable, in particular when the tubular section is to be used as a disposable element, and a new section is to be used for each measurement.

The advantages to be achieved with an immersion probe according to the invention are particularly effective when they are used in a generic device for determining a physical and/or chemical property of a liquid or solid free-flowing material such as a metallic melt, in particular for carrying out laser-induced plasma spectroscopy. Accordingly, the further goal is achieved by a generic device that comprises an immersion probe according to the invention.

With a device according to the invention it is favorable if the immersion probe is releasably attached. This makes it possible, for example, to couple several immersion probes according to the invention optionally with an individual LIPS device, e.g., for testing at different points of a process chain, which is overall highly practicable and leads to a reduction in cost.

The object of the invention in terms of method is finally attained in that with a generic method the material is inserted as a jet and at an angle to the longitudinal axis of the tubular section and an analysis of the material thus inserted is carried out.

The advantages achieved through a method according to the invention are to be seen above all in that the material flows in independent of an angle of tilt of the immersion probe with respect to a surface of a melt or of a free-flowing material with a constant angle to the longitudinal axis of the tubular section, which is why even with a variable angle of tilt a constant measuring geometry can always be ensured. In addition to a freedom from oxides of the melt flowing in, with respect to laser-induced plasma spectroscopy another advantage is to be seen in that a spacing between focusing device and plasma generated is likewise constant, which is why particularly exact measurement or analysis results can be obtained. This can be carried out in a particularly simple manner in that a plasma is ignited inside the immersion probe on a surface of the jet and radiation emitted by the plasma is analyzed.

Although an angle in a broad range, e.g., of 45° to 135° can be selected, it is recommended to select the angle at approx. 90°. In this case a particularly simple measuring geometry is given, since the jet always flows into the immersion probe perpendicular to a longitudinal axis of the same.

In order to facilitate an inflow of the material, in particular with a high surface tension of a melt, it can be favorable for an underpressure to be applied in the tubular section during inflow of the material. At the same time, a desired atmosphere, in particular an inert gas atmosphere, can thereby be adjusted, which is advantageous for LIPS.

It is also advantageous if the tubular section is emptied by the application of an underpressure after inflow of material and analysis of the radiation emitted by the plasma, so that the entire volume of the tubular section can serve for collection of entered material for a further measurement.

In order to achieve a particularly rapid emptying of the immersion probe and in particular an emptying in the immersed state, it can further be provided for the emptying to be carried out by application of an overpressure in the tubular section.

Further advantages and effects of the invention are shown by the context of the specification and the following exemplary embodiments.

Some embodiment variants of an immersion probe according to the invention, which are to be understood merely by way of example, are shown in more detail below.

They show

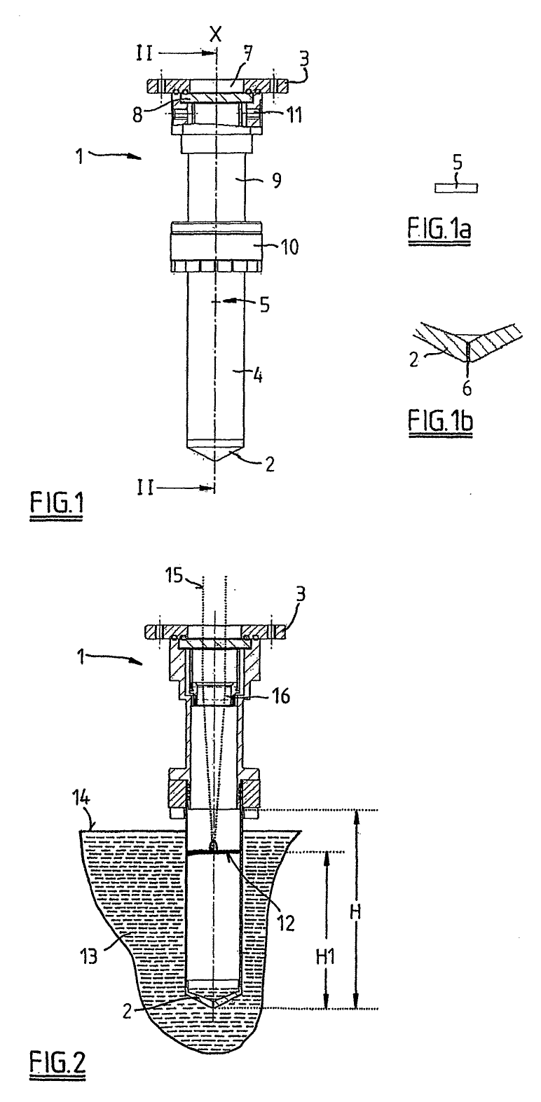

FIG. 1: An immersion probe according to the invention;

FIG. 1a: A lateral slot of an immersion probe according to FIG. 1;

FIG. 1b: A foot-side end of an immersion probe according to FIG. 1;

FIG. 2: A cross section through an immersion probe according to the invention according to FIG. 1 along the section line II-II in FIG. 1;

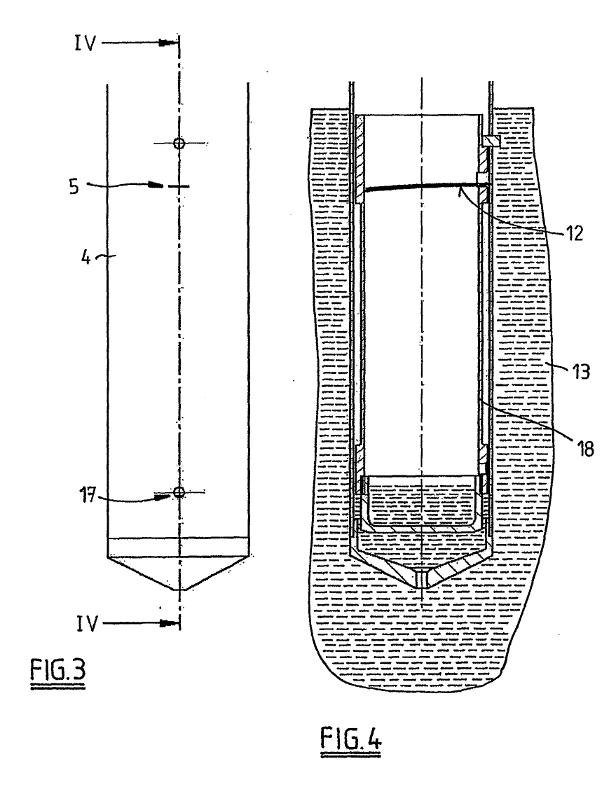

FIG. 3: A tubular section of an immersion probe according to the invention with two lateral openings;

FIG. 4: A cross section through an immersion probe according to FIG. 3 along the section line IV-IV in FIG. 3;

FIG. 5: A tubular section of an immersion probe according to the invention with two lateral openings;

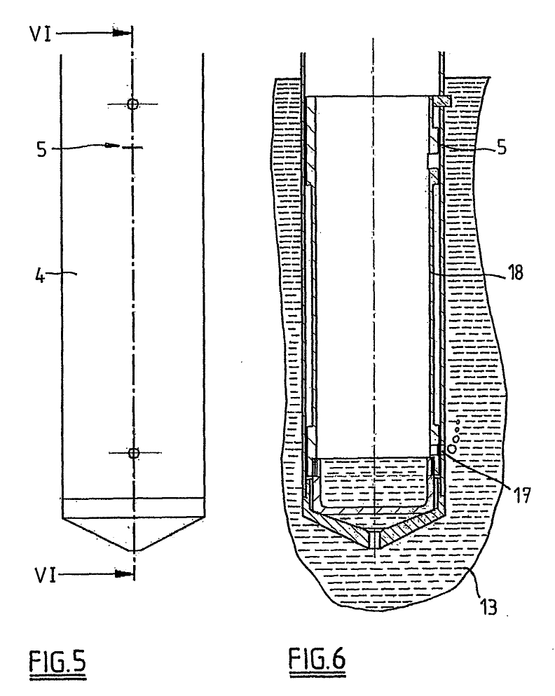

FIG. 6: A cross section of a tubular section according to FIG. 5 along the section line VI-VI in FIG. 5;

FIG. 7: A side view of an immersion probe according to the invention;

FIG. 8: A cross section through an immersion probe according to the invention according to FIG. 7 along the section line VIII-VIII in FIG. 7;

FIG. 9: A side view of an immersion probe according to the invention;

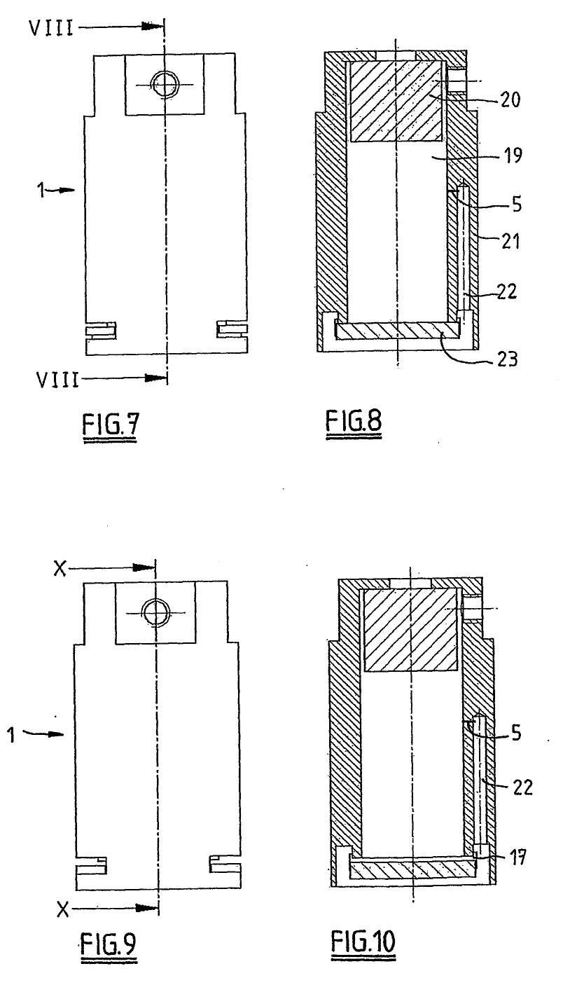

FIG. 10: A cross section through an immersion probe according to the invention according to FIG. 9 along the section line IX-IX in FIG. 9.

FIG. 1 shows an immersion probe 1 according to the invention in a more detailed representation. The immersion probe 1 has a conically tapering end 2, which at the same time forms the end of a tubular section 4. The tubular section 4, which, for example can comprise a ceramic or a steel, is hollow in the interior and has a lateral opening 5 or a slot through which material like a melt can enter in a jet-like manner. A further tubular section 9 adjoins the tubular section 4, wherein the two tubular sections 4, 9 are connected to one another in a gas-tight manner by means of a clamp ring 10. Both tubular sections run concentrically to a longitudinal axis X of the immersion probe 1 embodied in a rod-shaped manner. At a head-side end 3 the immersion probe 1 is closed by a window 8 permeable for electromagnetic radiation and adjoining it has a free cross section 7 to which for example an optical wave guide of an LIPS device can be connected. In order to be able to generate an overpressure or underpressure in the immersion probe, the immersion probe additionally has gas inlets and gas outlets 11.

FIG. 1a shows an opening 5 of an immersion probe 1 according to FIG. 1 in more detail. The opening 5 or the slot is embodied with a rectangular cross section. This is an advantage in that a cross section of this type causes a flat inflow of material essentially perpendicular to the longitudinal axis X.

Furthermore, FIG. 1b shows enlarged an end-side end 2 of an immersion probe according to FIG. 1. The conically tapering end 2 is essentially closed and has only at its lowest point an opening 6 with small dimensions, through which material entering during a measurement can be blown out or emptied after a measurement. The cross section of the opening 6 is dimensioned such that during a conventional measuring time for melts of, e.g., a minute only small amounts of melt can enter or be pressed in due to a hydrostatic pressure and the opening 5 remains free during the measurement.

FIG. 2 shows a cross section along the section line II-II of FIG. 1 and additionally in part a molten bath 13, in which an immersion probe is immersed. As can be seen from FIG. 2, with insertion of an immersion probe 1 into a melt 13 due to a given hydrostatic pressure material or melt enters the immersion probe 1 as a free-flowing jet 12, when a lateral opening of the same lies below a melt surface 14. At the same time, melt enters through the further second opening 6 shown in FIG. 1b at a foot-side end 2 of the immersion probe 1, which, however, is irrelevant for a measurement, since this is carried out on the free material jet 12. Namely, as can be further seen from FIG. 2, a plasma is ignited on the free material jet 12 by means of a laser beam 15, which is focused by means of an optical focusing device 16 (alternatively a plasma can also be ignited through spark discharge). Since melt constantly flows in after, the material jet 12 is essentially free of oxidic contaminants, and a chemical composition determined for the material jet 12 is characteristic of a chemical composition of the molten bath at height Hi. Furthermore, it can be seen from FIG. 2 that a lateral opening 5 is located in the upper half of the tubular section 4. Thus a sufficiently large internal volume for the collection of melt is available for a melt entering from below through the opening 6 during a measurement, without the entering melt reaching the area of a lateral opening 5 and the material jet 12 being hindered in its free propagation.

FIG. 3 shows in detail a tubular section 4 of an immersion probe according to the invention. The tubular section 4 thereby has two lateral openings 5, 17, wherein the opening 5 located at a greater height is embodied in a slit-like manner and ensures a flat inflow of a material.

A component 18 is attached in the interior of the tubular section shown according to FIG. 3, which component releases the lateral opening 5 with the application of an underpressure, thus under measuring conditions, whereas the lateral opening 17 is closed. With this variant of an immersion probe 1 according to the invention, a penetration of melt in the area of a foot-side end 2 during a measurement is limited, so that a free-flowing material jet 12 can be ensured over a long time period. This makes it possible to carry out measurements over a longer period of time compared to an immersion probe according to FIG. 1 and thus to achieve still greater reliability or precision with respect to the analysis results.

FIG. 5 or 6 show the same situation as in FIGS. 3 and 4 with the exception that an overpressure instead of an underpressure is applied in the tubular section. In this case a lateral opening 5 is closed by the component 18, but a lateral opening 17 is released or open. This means that any melt that is located above the opening 17 is pressed out of the tubular section 4 or is removed through the opening 17.

Another variant of an immersion probe 1 according to the invention with a valve function for closing a lateral opening and a further second lateral or foot-side opening is demonstrated based on FIGS. 7 through 10. An immersion probe 1 shown in front view according to FIG. 7 has, as can be seen from FIG. 8, in addition to optical components attached in the cavity 19 of the immersion probe 1, in particular a focusing device 20, a jacket 21 with a bore 22. This bore 22 is connected to a lateral opening 5. If, as shown in FIG. 8, an underpressure is applied in the cavity 19 of the immersion probe 1, a foot-side opening of the tubular section 4 is closed through a plate 23. Thus melt can enter the immersion probe 1 only through the lateral opening 5 and be analyzed.

If, however, an overpressure is applied with the same immersion probe 1 shown in FIG. 9, the plate 23 is pressed downward and any material in the immersion probe that has collected therein due to a measurement, can be pressed out through the lateral openings 17. At the same time, since an overpressure is also applied to the opening 5, it is ensured that no further melt rises along the bore 22 and enters the immersion probe via the opening 5.

It is evident to one skilled in the art that the embodiment variants of an immersion probe 1 according to the invention shown based on FIGS. 1 through 10 and their description are to be understood merely by way of example and do not in any way restrict the scope of protection of the patent claims.

1. Immersion probe (1) for a device for carrying out laser-induced plasma spectroscopy in a liquid or solid free-flowing material, such as a metallic melt, which immersion probe (1) has a tubular section (4) extending from a foot-side end (2) of the immersion probe (1) about a longitudinal axis (X) of the same and an opening for material to flow in, characterized in that the tubular section (4) is embodied essentially closed or closeable on the foot-side end (2) and has a lateral opening (5) through which the material can be inserted into the tubular section as a free flowing jet (12) directed at an angle (α) to the longitudinal axis (X).

2. Immersion probe (1) according to claim 1, characterized in that the angle (α) is an angle of 45° to 135°, in particular approximately a right angle.

3. Immersion probe (1) according to claim 1, characterized in that the opening (5) has a rectangular cross section, the shorter sides of which run parallel to the longitudinal axis (X).

4. Immersion probe (1) according to claim 1, characterized in that the tubular section (4) is embodied with a circular cross section.

5. Immersion probe (1) according to claim 4, characterized in that the tubular section (4) is embodied flat on the inside in the area of the lateral opening (5).

6. Immersion probe (1) according to claim 1, characterized in that means are provided for generating underpressure or a vacuum in the tubular section (4).

7. Immersion probe (1) according to claim 1, characterized in that at least one further second opening (6) is provided in the area of the foot-side end (2), and that the lateral opening (5) lies between the second opening (6) and a head-side end (3) of the immersion probe (1).

8. Immersion probe (1) according to claim 7, characterized in that the at least one further second opening (6) is made laterally.

9. Immersion probe (1) according to claim 7, characterized in that a free cross section of the second opening (6) is greater than a free cross section of the lateral opening (5).

10. Immersion probe (1) according to claim 7, characterized in that the lateral opening (5) is located at half the height (H) of the tubular section (4) or higher.

11. Immersion probe (1) according to claim 7, characterized in that means are provided for application of pressure to the tubular section (4).

12. Immersion probe (1) according to claim 7, characterized in that a component is provided for closing the lateral opening (5).

13. Immersion probe (1) according to claim 7, characterized in that a component is provided for closing the at least one further second opening (6).

14. Immersion probe (1) according to claim 7, characterized in that a component is provided in the tubular section (4) through which alternatively one of the openings (5, 6) can be closed.

15. Immersion probe (1) according to claim 14, characterized in that the component can be activated by generation of an underpressure or overpressure in the tubular section (4), wherein the second opening (6) can be closed through generation of an underpressure.

16. Immersion probe (1) according to claim 1, characterized in that the tubular section (4) of the immersion probe (1) comprises a ceramic, in particular silicon nitride.

17. Immersion probe (1) according to claim 1, characterized in that the tubular section (4) comprises a steel, which is preferably coated or provided with a facing material.

18. Immersion probe (1) according to claim 1, characterized in that the tubular section (4) comprises a steel and a ceramic insert defining the lateral opening (5) is releasably attached in the tubular section (4).

19. Immersion probe (1) according to claim 1, characterized in that a filter is respectively arranged in front of the opening (5) or the openings (5, 6) on the outside.

20. Immersion probe (1) according to claim 1, characterized in that the tubular section (4) is removable.

21. Device for determining a physical and/or chemical property of a liquid or solid free-flowing material such as a metallic melt, in particular for carrying out laser-induced plasma spectroscopy, comprising an immersion probe (1) which has a tubular section (4) extending from a foot-side end (2) of the immersion probe (1) about a longitudinal axis (X) of the same with an opening for material to flow in, and an analysis device connected to the immersion probe (1), with which a property of the material flowing into the immersion probe (1) can be analyzed, characterized in that the device comprises an immersion probe (1) according to claim 1.

22. Device according to claim 21, characterized in that the immersion probe (1) is releasably attached.

23. Device according to claim 21, characterized in that a window (7) is placed at a head-side end (3) of the immersion probe (1), through which window electromagnetic radiation can pass.

24. Method for determining a physical and/or chemical property of a liquid or solid free-flowing material such as a metallic melt, in particular for carrying out laser-induced plasma spectroscopy, wherein an immersion probe (1) having a tubular section (4) with an opening is inserted into the material and material is allowed to flow in, wherein properties of the material flowing in are analyzed, characterized in that the material is inserted as a jet and directed at an angle (α) to the longitudinal axis (X) of the tubular section (4) and an analysis of the material thus inserted is carried out.

25. Method according to claim 24, characterized in that a plasma is ignited on a surface of the jet inside the immersion probe (1), and radiation emitted by the plasma is analyzed.

26. Method according to claim 25, characterized in that the angle (α) is 45° to 135°, in particular approximately 90°.

27. Method according to claim 25, characterized in that an underpressure is applied in the tubular section (4) during the inflow of the material.

28. Method according to claim 25, characterized in that the tubular section (4) after inflow of material and analysis of the radiation emitted by the plasma is emptied.

29. Method according to claim 28, characterized in that the emptying is carried out by application of an overpressure to the tubular section (4).
